(19) United States
(12) Patent Application Publication
(10) Pub. No.: US 2010/0254632 A1
(43) Pub. Date: Oct. 7, 2010

(54) BAG FOR AUTOMATED MACHINES WITH SIDE FOLD

(76) Inventor: Jakob Schneider, Niederkassel (DE)

Correspondence Address: KF ROSS PC, 5683 RIVERDALE AVENUE, SUITE 203 BOX 900, BRONX, NY, 10471-0900, US

(21) Appl. No.: 12/742,503

(22) PCT Filed: Oct. 8, 2008
(86) PCT No.: PCT/EP2008/008508

§ 371 Date: May 26, 2010

(30) Foreign Application Priority Data
Dec. 1, 2007 (DE) 10 2007 057 942.1

(51) Int. Cl. B65D 33/14; B65D 30/20; B65D 33/00; B65B 1/04; B31B 1/26

(52) U.S. Cl. 383/11; 383/120; 383/32; 53/473; 493/243

(57) ABSTRACT

The invention relates to a side-folded bag (1) for use in a packaging machine made of a foil material and having a bag wall (2), a bag seam (3), at least one and preferably two side folds (6a, 6b) and a fill opening (4). The side-folded bag (1) according to the invention is characterized in that a hanger (9) made of a foil material and attached to the bag wall (2) in an adhesive fashion is provided with at least one fixing or blocking point (5a, 5b). The invention further relates to a stack comprising such bags and the use of said stack in a packaging machine and a production method for the bag.

The invention relates in general to a side-gusset bag made of a foil material for use in a packaging machine. The bag comprises face panels, a bottom seam, side gussets and a fill opening. The invention relates further to a stack formed from a plurality of the side-gusset bags and the use of this stack in a packaging machine and a production method for the bag.

Such side-gusset bags are known, for example, from DE 199 16 646 A1. They are characterized in that the bag has gussets laterally flanking the fill opening, so that when unfolded the bag volume increases so as to receive a product to be contained. Due to this longitudinal fold extending to the fill opening, despite a large receiving volume, the side-gusset bag has a small storage volume when empty, that is, when folded up. Moreover, compared to so-called bottom-fold bags which have only one fold at the bottom, the side-gusset bag can adapt better to the volume of the product to be packed which is not only of advantage with respect to the visual appearance with a virtually box-shape appearance but also with respect to the necessary storage volume when full, in particular when packaging bulk material. All this makes the use of the side-gusset bag in packaging machines desirable.

However, these side gussets interfere in most cases with the use of side-gusset bags in a packaging machine. The reason for this is that on the one hand it is important to hold the bag near the fill opening at at least one, in most cases two fixing points spaced apart from one another so that the product can be poured properly into the bags, this means, among other things, without spillage; when held, the inwardly folded sections of the face panels are in the way. Moreover, for storage, transport to the packaging machines and for the use in the packaging machine, a stacked block of a plurality of bags is needed so that they are easy to handle. Here too, the folds that extend to the fill opening interfere with this so that until now in practice in most cases bags without side gussets or bags that have only a bottom gusset were used. To solve the problem, DE 199 16 646 proposes providing side-gusset bags with tear-off tabs on the side facing the fill opening and near the side gussets for easier handling. These tear-off tabs are delimited by a perforation line. This has the disadvantage that after tearing off the tear-off tabs, the edges of the fill opening not only look unappealing but the tear-off process is uncontrolled, resulting in damage such as tearing and overstretching the face panels forming the as package.

Therefore it is the object of the present invention to provide for use in a packaging machine a side-gusset bag made of foil and comprising face panels, a bottom seam, side gussets and a fill opening, which bag on the one hand can be securely fixed and/or blocked to form a stack, for example during storage, transport, and/or use in the packaging machine and that on the other hand ensures that this does not affect the face panels forming the package. This object is solved by a side-gusset bag according to claim 1 and a stack according to claim 9. A use which is advantageous in this meaning is the subject matter of claim 10. Claim 11 relates further to an equally advantageous production method. Each of the dependent claims relates to advantageous embodiments.

The invention relates to a side-gusset bag for use in a packaging machine. The side-gusset bag consists substantially of a foil material, preferably a thermoplastic plastic foil, for example made of polyethylene. Also, the foil material can have several layers of different foils. The side-gusset bag comprises face panels, a bottom seam, side gussets and a fill opening at the bag end opposite the bottom seam. The side-gusset bag according to the invention is characterized in that a hanger is attached to one of the face panels by an adhesive and has fixing and/or blocking point(s). Here, the hanger is substantially made of a foil material, for example the same foil material as the face panels of the side-gusset bag. By means of the fixing and/or blocking point(s), the hanger can be held solidly in a packaging machine and/or for blocking a plurality of stacked bags to form a stack of interconnected bags to facilitate storage and transport of the bags and/or the filling of the packaging machine with the bags. For a particularly firm fixing and/or blocking, at least two fixing and/or blocking points are provided in a preferred embodiment.

The invention is not limited with respect to the manner in which the adhesive attachment of the hanger on the face panels is achieved. For example, the hanger is attached to the face panels by means of a releasing pressure-sensitive adhesive (noncuring adhesive). For example, the pressure-sensitive adhesive contains, besides additives such as softeners and the like, at least one base polymer selected from different rubber polymers (CR, NBR, SBR), acrylates, modified polyesters, ethylvinylacetate copolymers, polyurethanes, polysiloxane elastomers, modified phenolic resin, melamine resin. The adhesion between face panels and hanger can take place by evaporation of a solvent contained in the adhesive, pr by thermal influence or radiation cross-linking (for example UV irradiation). The adhesion between hanger and face panels is achieved in further embodiments by an adhesive transfer tape or a double-sided adhesive tape, i.e. a support tape coated on both sides with pressure-sensitive adhesive.

Due to the adhesive attachment, the hanger, which is not necessary anymore after packaging with the side-gusset bag, can easily and mostly residue-free be separated from the face panels without mechanically affecting them. For example, overstretching and tears, which cannot be avoided in case of a perforation line, can easily be avoided by adjusting the adhesive power of the adhesive. In addition, the hanger can be attached at almost any position on the bag, so that the side gussets provided between the face panels do not disturb and, on the other hand, attachment without interference by the side gussets and their function can be selected in such a manner that the blocking and/or fixing can be done in a very effective manner. As already mentioned above, in this manner, the side-gusset bags can be put to use in packaging machines, the side-gusset bags being characterized by a comparatively large and attractive box-shaped packing format and, when storing, space-saving appearance, and a small volume when empty.

Preferably, the hanger with the fixing/and or blocking point(s) is provided in such a manner that it projects from the face panels at least partly. This makes the access easier during blocking as well as during fixing in the packaging machine.

Preferably, the hanger is provided near the fill opening so as to be able to fix the bag and keep it open during filling with the material to be packaged.

In a preferred embodiment, the hanger is attached by an adhesive to the outside of one of the face panels. This way, the filling process is not affected.

Preferably, the fixing and/or blocking point(s) are formed as holes and thus serve, for example, for receiving a so-called wicket for blocking the stack or for receiving wicket pins of a wicket conveyor.

In a further embodiment, a tearing aid is provided in the hanger near the fixing and/or blocking point. This way, for example, after packaging and separation from the face panels, the hanger can be removed from the packaging machine, or can be removed from the wicket or the wicket pin of the wicket conveyor.

Furthermore, according to the invention it is also conceivable to construct the hanger of several parts. In a preferred embodiment, the hanger is formed by two hangers attached adjacent each other on the bag. This can be of advantage in particular if a very low tear-off force for the hangers on the bag is required, or if minimal material waste caused by the hangers is required. Depending on requirement and design of the bag, for example in case of very wide bags, it is also conceivable to attach three or more separate hangers to the bag.

According to a further advantageous embodiment, the face panels each have a straight edge near the fill opening when the side gussets are folded flat so that the filling process is easier.

In a further advantageous embodiment, the face panels has a rectangular shape when the side gussets are folded flat. This way, in particular in case of an article to be packaged from loose or soft material, a nearly box-like shape of the packaged article and thus an efficient, i.e. space-saving storage and transport is achieved.

The invention relates further to a stack, wherein in one of the previously described embodiments, a plurality of side-gusset bags are fixed to one another by means of the blocking point(s) provided on each of the hangers. For example, the fixing is achieved by a steel hoop and a holding sleeve which is or are inserted through the blocking point(s) formed as hole(s). Preferably, two holes are provided spaced apart from one another. This way, a stack is formed that is compact and thus easy to transport or suitable for filling by a packaging machine.

The invention relates further to the use of the stack in a packaging machine, preferably in an automatic packaging machine. In an embodiment of the invention, for example, the automatic packaging machine described in DE 199 35 065 [U.S. Pat. No. 6,508,588] is used, which hereby is incorporated by reference, the adhesive connection between hanger and face panels replacing the perforation line that must be ruptured and that is provided on the bag of DE 199 35 065.

The invention relates further to a method of producing a side-gusset bag according to one of the preceding embodiments, where from a tubular foil having a side gusset is provided in a first step with a bottom seam, for example by welding, and a parting seam without seam projection or a shrink seam with seam projection of, for example, 2 to 3 mm, and wherein the tubular foil is then cut through, if applicable independent of the welding process, to produce the face panels. In a second step, a hanger having fixing and/or blocking point(s) is adhered to one of the face panels, preferably by using a pressure-sensitive adhesive.

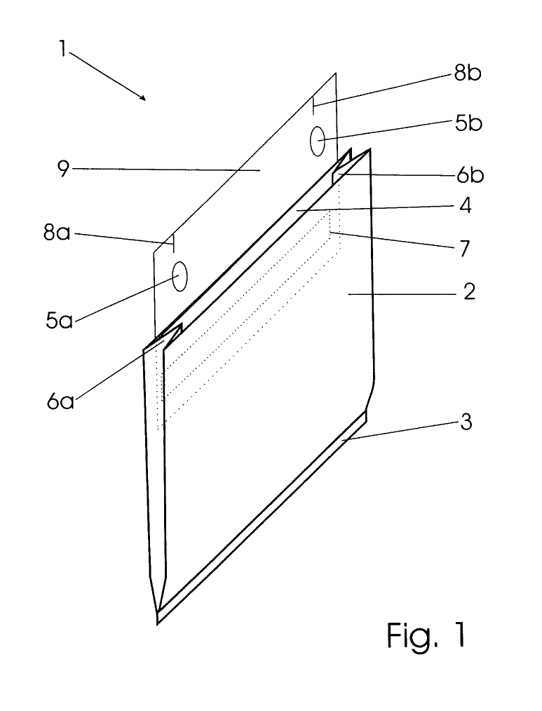

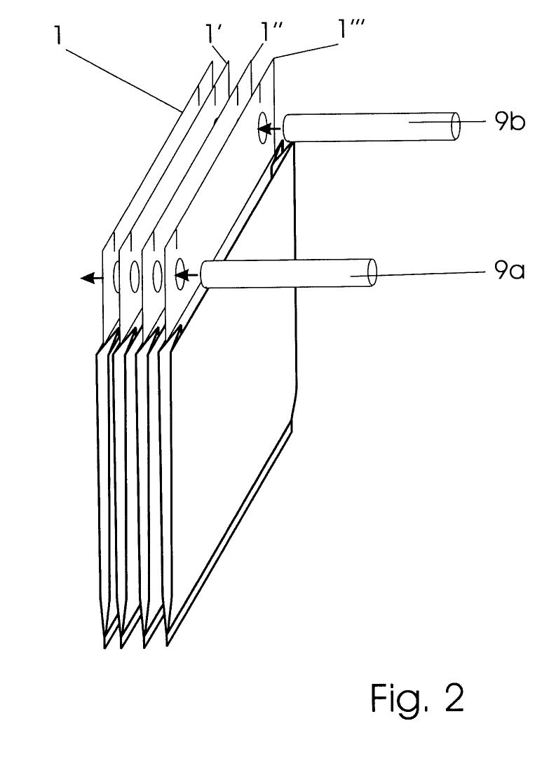

In the attached FIGS. 1 and 2, a preferred embodiment of the side-gusset bag according to the invention and a stack formed from a plurality of side-gusset bags are illustrated.

The perspective side view of FIG. 1 shows a side-gusset bag 1 made of a thermoplastic plastic foil, the bag having a face panel 2 that is closed at the bottom by a seam 2 to form a bag-shaped cavity serving to receive a bulk product and thus for packaging same, the product (not shown) being poured into the bag-shaped cavity through a fill opening 4 located on the side-bag end opposite the bottom seam 2. To allow a volume change of the cavity caused by the product, two side gussets 6a and 6b are provided between the face panels 2, which side gussets extend laterally and parallel and are folded inward in the empty state. These gussets 6a and 6b extend from the bottom seam 3 to the fill opening 4. Near the fill opening 4, a hanger 9 made of a thermoplastic plastic foil is attached by an adhesive to the outside of one of the relatively large-area sections of one of the face panels 2. This adhesive attachment is achieved by a layer 7 of a pressure-sensitive adhesive between the confronting faces. The hanger 9 projects from the face panels and is provided near its outermost corners with holes 5a and 5b that serve as fixing and/or blocking points. As shown in FIG. 2, a plurality of side-gusset bags are blocked together by means of a steel hoop or two holding sleeves 9a and 9b inserted into the holes 5a, 5b to form a stack, as indicated in FIG. 2. To be able to easily remove the hangers 9 that, after packaging, remain attached on the steel hoops or the holding sleeves 9a and 9b, tear-off aids 8a and 8b in the form of perforations or slots near the holes 5a and 5b are optionally provided.

1. A side-gusset bag for use in a packaging machine made of foil material and comprising face panels, a bottom seam, at least one and preferably two side gussets, and a fill opening, characterized by a hanger made of foil material, attached by an adhesive to one of the face panels, and comprising at least one and preferably at least two fixing or blocking points.

2. The side-gusset bag according to claim 1, wherein the hanger comprising the fixing or blocking point projects from the one face panel at least partially.

3. The side-gusset bag according to claim 1 wherein the hanger is provided near the fill opening.

4. The side-gusset bag according to claim 1 wherein the hanger is attached by an manner to the outside of the face panels.

5. The side-gusset bag according to claim 1 wherein the fixing or blocking point is formed as a hole.

6. The side-gusset bag according to claim 1 wherein a tearing aid is provided in the hanger near the fixing or blocking point.

7. The side-gusset bag according to claim 1 wherein the hanger is configured as a multi-part design and consists in particular of two separate hangers.

8. The side-gusset bag according to claim 1 wherein the face panels each have a straight edge near the fill opening when the side gussets are folded flat.

9. The side-gusset bag according to claim 1 wherein the face panels have a rectangular shape when the side gussets are folded flat.

10. A stack, characterized by a plurality of side-gusset bags according to claim 1 wherein the side-gusset bags are fixed to one another by means of the at least one blocking point.

11. A use of the stack according to claim 10 in a packaging machine, preferably in an automatic packaging machine.

12. A method of producing a side-gusset bag according to claim 1, wherein in a first step the face panels are produced from a tubular foil having a side gusset by incorporating the bottom seam and cutting the tubular foil, wherein in a second step a hanger having fixing or blocking point is adhered onto face panels.
